(19) United States
(12) Patent Application Publication
(10) Pub. No.: US 2007/0089442 A1
(43) Pub. Date: Apr. 26, 2007

(54) Temperature control system for a vehicle battery

(76) Inventor: Takenori Tsuchiya, Toyota-shi (JP)

Correspondence Address: KENYON & KENYON LLP, 1500 K STREET N.W., SUITE 700, WASHINGTON, DC, 20005, US

(21) Appl. No.: 10/576,475

(22) PCT Filed: Mar. 1, 2005
(86) PCT No.: PCT/IB05/00511

§ 371 Date: Apr. 20, 2006

(30) Foreign Application Priority Data
Nov. 3, 2004 (JP) 2004-069067

(51) Int. Cl. F25D 17/04; B60H 1/32; F25D 23/12

(52) U.S. Cl. 62/186; 62/259.2; 62/244

(57) ABSTRACT

Replace the abstract with the following new abstract: A temperature requested by a battery pack is achieved efficiently and promptly. A battery pack cooling system includes a battery fan for cooling a battery pack in a down flow method; a changing damper which changes air to be supplied to the battery pack by using the battery fan among air in a vehicle compartment, air in a luggage compartment and air whose heat has been exchanged with a rear air conditioning unit; a temperature sensor which measures a battery temperature; and a battery ECU which controls the changing damper and the electric fan based on the battery temperature, a temperature in the vehicle compartment, and a temperature in a luggage compartment and which outputs an operation request signal for the rear air conditioning unit to an air conditioning ECU.

### BACKGROUND OF THE INVENTION

1. Field of the Invention

The invention relates to a temperature control system for a vehicle, which controls a temperature of a power supply for running such as a battery mounted in a vehicle, for example, an electric vehicle, a hybrid vehicle, or a fuel cell vehicle. More particularly, the invention relates to a temperature control system for a vehicle, which can efficiently control a temperature of a power supply for running.

2. Description of the Related Art

Each of an electric vehicle, a hybrid vehicle, and a fuel cell vehicle, each of which obtains driving force for the vehicle using an electric motor, is provided with a secondary battery as a power supply for running. In the case of the electric vehicle, the vehicle is driven by driving an electric motor using the electric power stored in the secondary battery. In the case of the hybrid vehicle, the vehicle is driven by driving an electric motor using the electric power stored in the secondary battery, or the vehicle is driven by assisting an engine using the electric motor. In the case of the fuel cell vehicle, the vehicle is driven by driving an electric motor using the electric power generated by a fuel cell, or the vehicle is driven by driving the electric motor using the electric power stored in the secondary battery in addition to the electric power generated by the fuel cell.

The above-mentioned secondary battery needs to generate high voltage and high output. Accordingly, for example, a battery pack is formed by placing approximately 30 battery modules in series, each of which is formed by placing approximately six 1.2-volt battery cells in series. The hybrid vehicle or the like needs to be provided with such a secondary battery which is not mounted in a conventional vehicle that includes only an internal combustion engine as a drive source for the vehicle. In terms of effective use of a vehicle compartment space and a luggage compartment space, ensuring of safety in the event of a collision, and the like, it is necessary to consider a position, in the vehicle, at which the secondary battery is provided, since the secondary battery has a large volume as compared to the other electrical apparatuses mounted in the vehicle. In this consideration, it is necessary to take a size (a height, a length in the width direction of the vehicle, and a length in the longitudinal direction of the vehicle) of the secondary battery into consideration. Also, it is necessary to take a temperature of the secondary battery into consideration.

Such a secondary battery can achieve desired output performance and can be used for a longer time, if an operating temperature thereof is constantly in a predetermined range. Therefore, it is suggested that the secondary battery be heated in order to achieve the output performance of the secondary battery when the secondary battery is used in an extremely cold state, and the secondary battery be cooled in order to ensure the life of the secondary battery.

Japanese Patent Application Publication No. 10-252467 (publication 1) discloses a battery temperature control apparatus for an electric vehicle, which increases heat utilization efficiency at the time of cooling or heating of a battery. The battery temperature control apparatus for an electric vehicle includes an introduction passage which extends from a vehicle compartment to the inside of a battery storage case; and a discharge passage which extends from the battery storage case to the outside of the vehicle. The battery for driving a vehicle, which is stored in the battery storage case, is cooled or heated by the air which has been used for air conditioning in the vehicle compartment and introduced into the battery storage case through the introduction passage. The air which has been used for cooling or heating of the battery is discharged to the outside of the vehicle through the discharge passage. In addition, when gas is released from the battery, the gas is discharged to the outside of the vehicle through the discharge passage.

With the battery temperature control apparatus for an electric vehicle, it is possible to appropriately perform both sufficient air conditioning in the vehicle compartment and sufficient cooling/heating of the battery, since the air which has been used for the air conditioning in the vehicle compartment is introduced into the battery storage case through the introduction passage and the air that has been used for cooling or heating of the battery for driving a vehicle, which is stored in the battery storage case, is discharged to the outside of the vehicle through the discharge passage. Also, unnecessary energy consumption can be reduced by using waste heat. In addition, even when a battery which may release gas is used, the released gas is temporarily accumulated in the battery storage case, and then discharged to the outside of the vehicle through the discharge passage. It is therefore possible to prevent the gas from being leaked to the vehicle compartment and the comfort in the vehicle compartment from being reduced.

Japanese Patent Application Publication No. 07-73906 (publication 2) discloses a charging apparatus for an electric vehicle, which can maintain a temperature of a battery at the optimum value in order to efficiently perform charging/discharging of the battery while minimizing an increase in a weight of an electric vehicle. The charging apparatus for an electric vehicle includes an in-vehicle air conditioning unit which performs air conditioning in a vehicle compartment, and a battery which can be charged by an external power supply. More particularly, the charging apparatus for an electric vehicle includes a communication passage which permits communication between a storage space in which the battery is stored and the in-vehicle air conditioning unit; temperature detecting means for detecting a temperature of the battery and outputting a detection signal; and temperature control means for supplying cooling air or heating air from the in-vehicle air conditioning unit to the storage space through the communication passage according to the detection signal from the temperature detecting means at least when the battery is charged, and cooling or heating the battery, thereby maintaining the temperature of the battery at a desired value.

With the charging apparatus for an electric vehicle, the temperature detecting means detects the temperature of the battery, and the temperature control means controls the in-vehicle air conditioning unit according to the detection signal output from the temperature detecting means. Then, cooling air or heating air is supplied into the storage space in which the battery is stored through the communication passage.

Japanese Patent Application Publication No. 10-306722 (publication 3) discloses a battery cooling system for a vehicle, which efficiently performs cooling of a battery using air in a vehicle compartment without reducing the comfort in the vehicle compartment where air conditioning is performed. The battery cooling system for a vehicle maintains a temperature of the battery in a predetermined temperature range by cooling the battery provided in a vehicle having the vehicle compartment where air conditioning is performed by an air conditioning unit. More particularly, the battery cooling system for a vehicle includes a battery chamber in which the battery is stored; cooling means for cooling the battery by supplying air in the vehicle compartment to the battery chamber by using a cooling fan; cooling air circulating means for introducing the air, which has been used for cooling the battery, into the vehicle compartment thereby circulating the air between the battery chamber and the vehicle compartment; discharging means for discharging the air, which has been used for cooling the battery, to the outside of the vehicle; changing means for selecting the circulating means or the discharging means; temperature detecting means for detecting at least one of a temperature in the battery chamber and a temperature of the battery; and changing control means for selecting the discharging means using the changing means when the temperature detected by the temperature detecting means becomes equal to or higher than a predetermined value.

The battery cooling system for a vehicle detects the temperature in the battery chamber or the temperature of the battery, and controls the changing means based on the detection result. If the temperature of the battery is high, the circulating means is not selected, and the discharging means is selected. It is therefore possible to prevent the situation where the cooling air, which has been used for cooling the battery and whose temperature has become high, is returned to the vehicle compartment and the comfort in the vehicle compartment is reduced. Also, it is possible to prevent an increase in a load due to air conditioning.

However, the apparatus and systems disclosed in the above-mentioned publications have the following problems.

The battery temperature control apparatus disclosed in the publication 1 merely cools or heats the battery by using the air which has been used for air conditioning in the vehicle compartment. The exhaust is discharged to the outside of the vehicle merely on the assumption that gas leaks from the battery.

The battery cooling system disclosed in the publication 3 cools the battery using the air in the vehicle compartment. The battery cooling system merely changes the state among the state where the exhaust gas from the battery is returned to the vehicle compartment, the state where the exhaust gas is discharged to the outside of the vehicle, and the state where one part of the exhaust gas is discharged to the outside of the vehicle while the other part of the exhaust is returned to the vehicle compartment, using a changing damper.

In order to efficiently and promptly cool or heat the secondary battery for running mounted in the vehicle such that the temperature of the secondary battery becomes an appropriate value, as disclosed in the publication 2, it is preferable that the in-vehicle air conditioning unit which forms a cooling cycle and the battery be connected to each other by a duct, instead of taking in the air in the vehicle compartment as disclosed in each of the publications 1 and 3.

However, the charging apparatus for an electric vehicle disclosed in the publication 2 does not charge the battery by using an electric motor mounted in the vehicle. The charging apparatus charges the battery merely by using electric power supplied from a charging equipment located outside the vehicle while the vehicle is stopped.

In the case where a motor generator is mounted in a vehicle and a battery is charged by electric power generated due to regenerative braking, charging of the battery is performed while the vehicle is running. In order to control the temperature of the battery in such a case, as disclosed in the publication 2, the air conditioning unit and the battery may be connected to each other by the duct, and the battery is directly cooled or heated using an air conditioner.

In this case, however, the in-vehicle air conditioning unit, which forms the cooling cycle for controlling the temperature in the vehicle compartment, is also used for controlling the temperature of the battery. Therefore, the cooling ability and the heating ability need to be increased by the amount of the maximum ability requested by the battery, as compared to the conventional in-vehicle air conditioning unit. As a result, an increase in cost and an energy loss may be caused. Also, if the temperature requested by the battery do not match the temperature requested by a passenger of the vehicle, a problem occurs. Also, there is a high possibility that such a problem occurs, since the temperature requested by the battery changes according to the state of charge of the battery. For example, a problem occurs in the case where an outside temperature is low, a charging/discharging current value of the battery is high and the battery needs to be cooled, and the passenger needs heating. In this case, it is difficult to satisfy both the request from the battery and the request from the passenger.

### SUMMARY OF THE INVENTION

It is an object of the invention to provide a temperature control system for a vehicle, which can promptly achieve a temperature requested by a storage mechanism that is a power supply for running such as a battery and a capacitor.

According to an aspect of the invention, there is provided a temperature control system for a vehicle, including supply means for supplying air for controlling a temperature to a storage mechanism; an inlet port which is communicated with the supply means; and changing means for changing air to be supplied to the storage mechanism by the supply means between air whose heat has been exchanged with an air conditioning unit in the air pipe and which has passed through the air pipe, and air other than the air whose heat has been exchanged with the air conditioning unit, the changing means being provided in an air pipe between the supply means and the inlet port.

The changing means changes the air to be supplied to the storage mechanism between the air whose heat has been absorbed by an evaporator of the air conditioning unit and whose temperature has been decreased (when the storage mechanism is cooled) or the air which has absorbed heat from a heater core of the air conditioning unit and whose temperature has been increased (when the storage mechanism is heated), and the air in a vehicle compartment. The supply means supplies the air which has been selected by the changing means to the storage mechanism through the air pipe. For example, when the temperature of the storage mechanism needs to be decreased rapidly and the temperature of the air in the vehicle compartment is high, the changing means performs changing such that the air whose heat has been absorbed by the evaporator of the air conditioning unit and whose temperature has been decreased is supplied to the storage mechanism by the supply means. On the other hand, when the temperature of the storage mechanism needs to be decreased and the temperature of the air in the vehicle compartment is low, the changing means performs changing such that the air in the vehicle compartment is supplied to the storage mechanism by the supply means. As described above, it is possible to change the air to be supplied to the storage mechanism by the supply means according to a request for cooling the storage mechanism. Namely, when the temperature of the air in the vehicle compartment is low, the storage mechanism can be cooled by using the air in the vehicle compartment without using the air conditioning unit. Therefore, it is not necessary to increase the cooling ability by the amount of the maximum ability requested by the battery. In addition, by using the air conditioning unit, it is possible to promptly deal with the request to rapidly decrease the temperature of the storage mechanism, and efficiently cool the storage mechanism. Also, when the temperature of the storage mechanism needs to be rapidly decreased, the air whose temperature is lower than the temperature of the air in the vehicle compartment can be supplied to the storage mechanism. Therefore, it is not necessary to increase the amount of cooling air to be supplied to the storage mechanism, unlike the conventional case. Further, when the temperature of the storage mechanism is low and the desired performance cannot be achieved, the air to be supplied to the storage mechanism is changed by the changing means such that the temperature of the storage mechanism can be increased further efficiently. Namely, when the temperature of the storage mechanism needs to be increased further promptly, the air whose temperature is higher is supplied to the storage mechanism by the supply means. As a result, it is possible to efficiently achieve the temperature requested by the power supply for running such as the battery and the capacitor.

In the temperature control system for a vehicle according to the above-mentioned aspect, the air other than the air whose heat has been exchanged with the air conditioning unit may be the air in the vehicle compartment. According to this configuration, when the temperature of the storage mechanism needs to be decreased rapidly, the changing means changes the air to be supplied to the storage mechanism such that the air whose heat has been absorbed by the evaporator of the air conditioning unit and whose temperature has been decreased is supplied to the storage mechanism by the supply means. When the temperature of the storage mechanism needs to be increased rapidly, the changing means changes the air to be supplied to the storage mechanism such that the air which has absorbed heat from the heater core of the air conditioning unit and whose temperature has been increased is supplied to the storage mechanism by the supply means. When there is no request to rapidly change the temperature of the storage mechanism, the changing means changes the air to be supplied to the storage mechanism such that the air in the vehicle compartment, that is, the air whose temperature has been controlled by the air conditioning unit is supplied to the storage mechanism by the supply means. As a result, it is possible to efficiently and promptly achieve the temperature requested by the power supply for running such as the battery and the capacitor.

The temperature control system for a vehicle according to the above-mentioned aspect may further include changing control means for controlling the changing means based on the temperature of the storage mechanism and the temperature in the vehicle compartment. According to this configuration, when the temperature of the storage mechanism needs to be decreased and the temperature in the vehicle compartment is not considerably low, the changing control means controls the changing means such that the air whose heat has been absorbed by the evaporator of the air conditioning unit and whose temperature has been decreased is supplied to the storage mechanism by the supply means. When the temperature of the storage mechanism needs to be rapidly decreased, the air whose temperature is lower than the temperature of the air in the vehicle compartment can be supplied to the storage mechanism.

In the temperature control system for a vehicle according to the above-mentioned aspect, the air other than the air whose heat has been exchanged with the air conditioning unit may be the air in the vehicle compartment and the air in the luggage compartment, and the changing means may change the air to be supplied to the storage mechanism among the air whose heat has been exchanged with the air conditioning unit, the air in the vehicle compartment, and the air in the luggage compartment. According to this configuration, the changing means is controlled such that the optimum air for controlling the temperature of the storage mechanism from among the air whose heat has been exchanged with the evaporator or the heater core of the air conditioning unit, the air in the vehicle compartment and the air in the luggage compartment, is supplied to the storage mechanism by the supply means. For example, when the storage mechanism needs to be cooled and the temperature in the luggage compartment is lower than the temperature in the vehicle compartment, the air in the luggage compartment is supplied to the storage mechanism, whereby the temperature of the storage mechanism can be controlled appropriately.

The temperature control system for a vehicle according to the above-mentioned aspect may further include changing control means for controlling the changing means based on the temperature of the storage mechanism, the temperature in the vehicle compartment and the temperature in the luggage compartment. According to this configuration, when the temperature of the storage mechanism needs to be decreased, the temperature in the vehicle compartment is not considerably low, and the temperature in the luggage compartment is low, the changing control means controls the changing means such that the air in the luggage compartment is supplied to the storage mechanism by the supply means, instead of the air whose heat has been absorbed by the evaporator of the air conditioning unit and whose temperature has been decreased. When the temperature of the storage mechanism needs to be decreased, the air in the luggage compartment whose temperature is lower than the temperature of the air in the vehicle compartment can be supplied to the storage mechanism. At this time, the load placed on the air conditioning unit can be prevented from increasing.

In the temperature control system for a vehicle according to the above-mentioned aspect, the changing control means may control the changing means such that, as the temperature of the storage mechanism becomes higher, the air whose temperature is lower is supplied to the storage mechanism. When the temperature of the storage mechanism such as the secondary battery becomes a temperature higher than the upper limit of a predetermined temperature range, the charging/discharging performance of the storage mechanism is reduced, and the battery life is decreased. According to the above-mentioned configuration, the temperature of the storage mechanism is monitored, and as the temperature of the storage mechanism becomes higher, the air whose temperature is lower can be supplied to the storage mechanism. It is therefore possible to prevent the charging/discharging performance from being reduced and the battery life from being decreased.

In the temperature control system for a vehicle according to the above-mentioned aspect, the changing control means may control the changing means such that, as the temperature of the storage mechanism becomes lower, the air whose temperature is higher is supplied to the storage mechanism. When the temperature of the storage mechanism such as the secondary battery becomes a temperature which is considerably lower than the lower limit of a predetermined temperature range, the discharging performance of the storage mechanism is considerably reduced. According to the above-mentioned configuration, the temperature of the storage mechanism is monitored, and when the temperature is low, the air whose temperature is high can be supplied to the storage mechanism. It is therefore possible to prevent the discharging performance from being considerably reduced.

In the temperature control system for a vehicle according to the above-mentioned aspect, the changing control means may control the changing means based on a change in the temperature of the storage mechanism. For example, when the temperature is not in a high temperature region (a region in which the charging/discharging performance is reduced and the battery life is decreased) but the temperature increases sharply, if this state is left as it is, the temperature reaches the high temperature region. Once the temperature enters the high temperature region, it is difficult to decrease the temperature of the storage mechanism. According to the above-mentioned configuration, when the temperature increases sharply, the changing means is controlled such that the air whose temperature is lower can be supplied to the storage mechanism by the supply means. It is therefore possible to prevent the temperature of the storage mechanism from reaching the high temperature region.

In the temperature control system for a vehicle according to the above-mentioned aspect, the changing control means may control the changing means such that, as a degree of an increase in the temperature of the storage mechanism becomes higher, the air whose temperature is lower is supplied to the storage mechanism. When the temperature of the storage mechanism increases sharply, there is a possibility that the temperature reaches the high temperature region in a short time. Once the temperature enters the high temperature region, it is difficult to decrease the temperature of the storage mechanism. According to the above-mentioned configuration, the changing means is controlled such that, when the temperature increases sharply, the air whose temperature is lower can be supplied to the storage mechanism by the supply means. It is therefore possible to prevent the temperature from reaching the high temperature region.

The temperature control system for a vehicle according to the above-mentioned aspect may further include supply control means for controlling the supply means based on the temperature of the storage mechanism. According to this configuration, it is possible to control operation/stop of a blower which supplies cooling air to the storage mechanism and an amount of air supplied from the blower based on the temperature of the storage mechanism.

In the temperature control system for a vehicle according to the above-mentioned aspect, the supply control means may control the supply means such that the supply means is operated when the temperature of the storage mechanism is higher than a predetermined threshold value. According to this configuration, when the temperature of the storage mechanism is in the high temperature region whose lower limit is higher than the threshold value (the region in which the charging/discharging performance is reduced and the battery life is decreased), the blower which supplies cooling air to the storage mechanism can be operated. At this time, it is possible to change the air to be supplied by the operated blower based on the temperature of the storage mechanism, and the temperature in the vehicle compartment or the temperature in the luggage compartment.

In the temperature control system for a vehicle according to the above-mentioned aspect, the supply control means may control the supply means such that the supply means is operated when the temperature of the storage mechanism is lower than the predetermined threshold value. According to this configuration, when the temperature of the storage mechanism is in a low temperature region whose upper limit is lower than the threshold value (a region in which the discharging performance is considerably reduced), the blower which supplies heating air to the storage mechanism can be operated. At this time, it is possible to change the air to be supplied by the operated blower based on the temperature of the storage mechanism, and the temperature in the vehicle compartment or the temperature in the luggage compartment.

In the temperature control system for a vehicle according to the above-mentioned aspect, the supply control means may control the supply means based on a change in the temperature of the storage mechanism. For example, when the temperature is not in the high temperature region (the region in which the charging/discharging performance is reduced and the battery life is decreased) but the temperature increases sharply, if the state is left as it is, the temperature reaches the high temperature region. Once the temperature enters the high temperature region, it is difficult to decrease the temperature of the storage mechanism. According to the above-mentioned configuration, when the temperature increases sharply, the blower which supplies the cooling air to the storage mechanism can be operated. It is therefore possible to prevent the temperature from reaching the high temperature region.

In the temperature control system for a vehicle according to the above-mentioned aspect, the supply control means may control the supply means such that the supply means is operated when an increase in the change in the temperature of the storage mechanism is higher than a predetermined threshold value. When the temperature of the storage mechanism increases sharply, there is a possibility that the temperature reaches the high temperature region in a short time. Once the temperature enters the high temperature region, it is difficult to decrease the temperature of the storage mechanism. According to the above-mentioned configuration, when the temperature increases sharply, the blower which supplies the cooling air to the storage mechanism can be operated. It is therefore possible to prevent the temperature from reaching the high temperature region.

The temperature control system for a vehicle according to the above-mentioned aspect may further include supply control means for controlling the supply means based on the temperature of the storage mechanism, wherein a low temperature side threshold value and a high temperature side threshold value are set for the temperature of the storage mechanism in advance; when the temperature of the storage mechanism is lower than the low temperature side threshold value, the changing control means controls the changing means such that the air whose heat has been exchanged with the air conditioning unit is used as the air to be supplied to the storage mechanism, and the supply control means controls the supply means such that the supply means is operated; when the temperature of the storage mechanism is higher than the low temperature side threshold value and lower than the high temperature side threshold value and the storage mechanism needs to be heated, the changing control means controls the changing means such that the air in the vehicle compartment or the air in the luggage compartment, which has the higher temperature, is used as the air to be supplied to the storage mechanism, and the supply control means controls the supply means such that the supply means is operated; and when the temperature of the storage mechanism is higher than the high temperature side threshold value and the storage mechanism need not be cooled nor heated, the supply control means controls the supply means such that the supply means is not operated.

In the temperature control system for a vehicle according to the above-mentioned aspect, the air whose heat has been exchanged with the air conditioning unit may be the air whose heat has been exchanged with one of the evaporator and the heater core. According to this configuration, it is possible to use the air whose heat has been exchanged with one of the evaporator and the heater core of the air conditioning unit (in this case, the air conditioning unit may be a rear air conditioning unit) for decreasing or increasing the temperature of the storage mechanism.

In the temperature control system for a vehicle according to the above-mentioned aspect, the storage mechanism may be mounted in a rear portion of the vehicle; the air conditioning unit may be a rear air conditioning unit, and the supply means may be a blower which supplied air to the storage mechanism. According to this configuration, the storage mechanism is provided in the rear portion of the vehicle; the air to be supplied to the storage mechanism can be appropriately changed among the air whose heat has been exchanged with the evaporator or the heater core of the rear air conditioning unit provided near the storage mechanism, the air in the vehicle compartment and the air in the luggage compartment; and the selected air can be supplied to the storage mechanism.

In the temperature control system for a vehicle according to the above-mentioned aspect, the storage mechanism may be a secondary battery for running. According to this configuration, it is possible to control a temperature of a nickel hydride battery or a temperature of a lithium ion battery, which is the secondary battery for running, such that the temperature becomes an appropriate value.

In the temperature control system for a vehicle according to the above-mentioned aspect, the air conditioning unit may include an evaporator and a heater core for the rear air conditioning unit provided near the storage mechanism in addition to an evaporator and a heater core for a front air conditioning unit. The air whose heat has been exchanged with the air conditioning unit in the air pipe is the air whose heat has been exchanged with the evaporator or the heater core of the rear air conditioning unit. According to this configuration, the air, whose heat has been exchanged with the evaporator or the heart core of the rear air conditioning unit provided in the rear portion of the vehicle in addition to the front air conditioning unit, is used for cooling the secondary battery for running, which is the storage mechanism. By controlling the operation of the front air conditioning unit and the operation of the rear air conditioning unit independently of each other, it is possible to satisfy both the request from the storage mechanism and the request from the passenger.

### BRIEF DESCRIPTION OF THE DRAWINGS

The above-mentioned embodiment and other embodiments, objects, features, advantages, technical and industrial significance of this invention will be better understood by reading the following detailed description of the exemplary embodiments of the invention, when considered in connection with the accompanying drawings, in which:

FIG. 1 is a view schematically showing an arrangement of a rear air conditioning unit and a battery pack included in a battery pack cooling system according to an embodiment of the invention;

FIG. 2 is a perspective view showing the battery pack cooling system according to the embodiment of the invention;

FIG. 3 is a front view showing the battery pack cooling system viewed from the rear side of a vehicle;

FIG. 4 is an enlarged view showing a battery pack in FIG. 3;

FIG. 5 is a side view showing the battery pack cooling system viewed from the side of the vehicle;

FIG. 6 is a control block diagram of the battery pack cooling system according to the embodiment of the invention; and

FIGS. 7A and 7B are a flowchart showing a routine of a program performed by a battery ECU in FIG. 6.

### DETAILED DESCRIPTION OF THE PREFERRED EMBODIMENTS

Hereafter, an embodiment of the invention will be described in detail with reference to the accompanying drawings. The same reference numerals will be assigned to the same components. The names and the functions of the components having the same reference numerals are also the same. Accordingly, the detailed description of the components having the same reference numerals will be made only once.

Hereafter, a description will be made concerning a battery pack cooling system which is used for controlling a temperature of a battery pack that is a secondary battery for running. However, the invention is not limited to such a cooling system. A target of cooling may be another power supply for running (storage mechanism) such as a capacitor. The invention may be applied to a system for heating the battery pack, or a temperature control system for cooling/heating the battery pack as requested, instead of the system for cooling the battery pack. Basically, the system for cooling the battery pack will be described. Concerning the system for heating of the battery pack, only part of the system will be described.

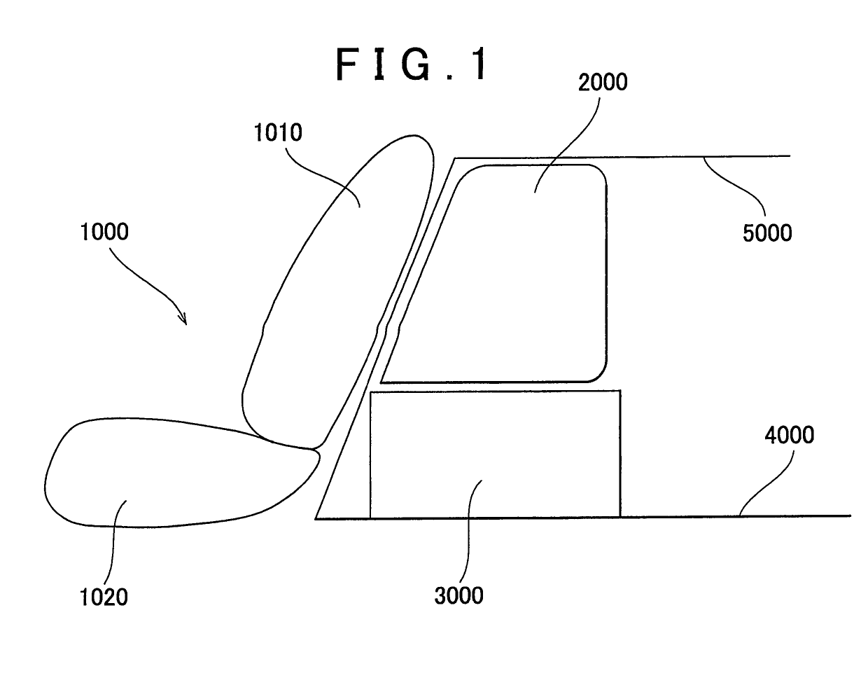

FIG. 1 shows an arrangement of a rear air conditioning unit 2000 and a battery pack 3000 which are included in a battery pack cooling system according to an embodiment of the invention.

As shown in FIG. 1, the rear air conditioning unit 2000 and the battery pack 3000 are provided on a floor panel 4000 and under an upper back panel 5000. As shown in FIG. 1, a rear seat 1000 includes a seat back 1010 and a seat cushion 1020. The rear air conditioning unit 2000 and the battery pack 3000 are provided in a rear portion of a vehicle at a position behind the rear seat back 1010.

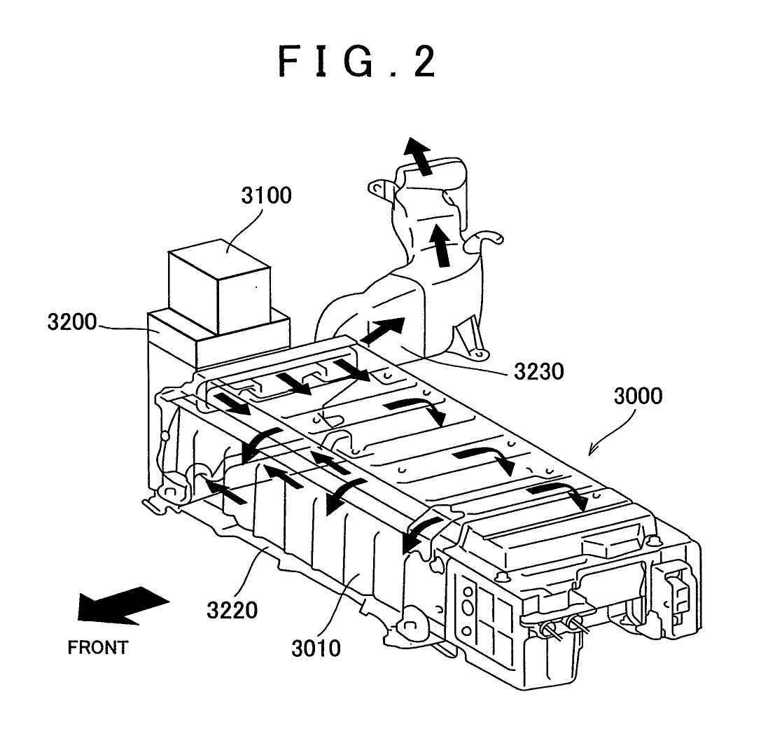

FIG. 2 is a perspective view showing the battery pack cooling system according to the embodiment of the invention. As shown in FIG. 2, the battery pack 3000 is a secondary battery which is formed by placing multiple battery cells 3010 in series and which has an output voltage of 200 to 300 volts. As described later, the battery pack cooling system includes a changing damper 3100; a battery fan 3200; a cooling passage; and an exhaust passage 3230. The changing damper 3100 supplies the battery fan 3200 with one of the air in a vehicle compartment, the air whose heat has been exchanged with an evaporator or a heater core of the rear air conditioning unit 2000, and the air in a luggage compartment. The battery fan 3200 introduces the air supplied from the changing damper 3100 into the battery pack 3000. The cooling passage cools the battery pack 3000 in a down flow method. The exhaust passage 3230 discharges the air whose heat has been exchanged with the battery pack 3000. As shown by arrows in FIG. 2, the air for cooling or heating is supplied to the battery pack 3000 by the battery fan 3200, and is discharged to the outside of the vehicle or the luggage compartment through the exhaust passage 3230.

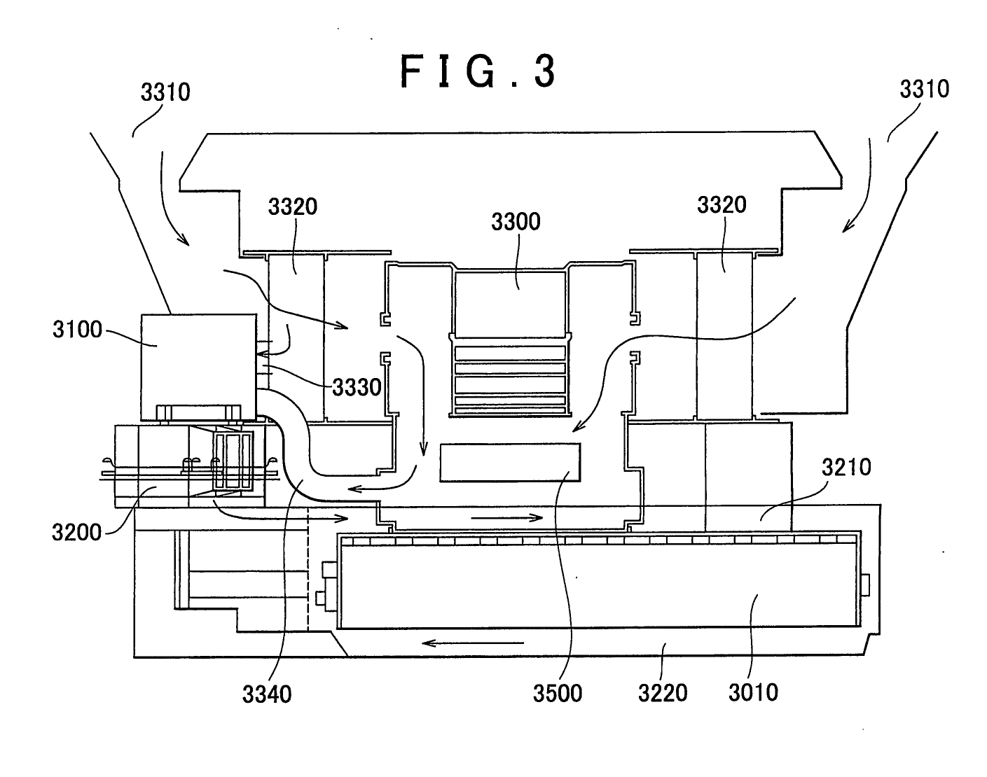

FIG. 3 is a front view showing the battery pack cooling system viewed from the rear side of the vehicle. As shown in FIG. 3, the battery pack cooling system includes vehicle compartment inlets 3310 (at two positions); an air conditioning filter 3320; an air conditioning blower 3300; and an evaporator 3500. The vehicle compartment inlets 3310 are formed in the upper back panel 5000. The air conditioning filter 3320 collects dust contained in the air taken in from the vehicle compartment inlets 3310. The evaporator 3500 absorbs heat of the air which has passed through the air conditioning filter 3320 and decreases the temperature of the air.

The battery pack cooling system further includes a vehicle compartment air intake passage 3330; an air conditioning air intake passage 3340; the battery fan 3200; an upper air passage 3210; and a lower air passage 3220. The vehicle compartment air intake passage 3330 introduces the air which has passed through the air conditioning filter 3320 to the changing damper 3100. The air conditioning air intake passage 3340 introduces the air which has passed through the evaporator 3500 to the changing damper 3100. The battery fan 3200 supplies the air selected by the changing damper 3100 to the upper air passage 3210 of the battery pack 3000. The upper air passage 3210 is a clearance formed in an upper portion of the battery pack 3000. The lower air passage 3220 is a clearance formed in a lower portion of the battery pack 3000.

The changing damper 3100 is controlled by an after-mentioned ECU (electronic control unit). More particularly, the changing damper 3100 is controlled such that one of the air in the vehicle compartment, the air in the rear air conditioning unit, and the air in the luggage compartment can be introduced into the battery pack 3000 by the battery fan 3200.

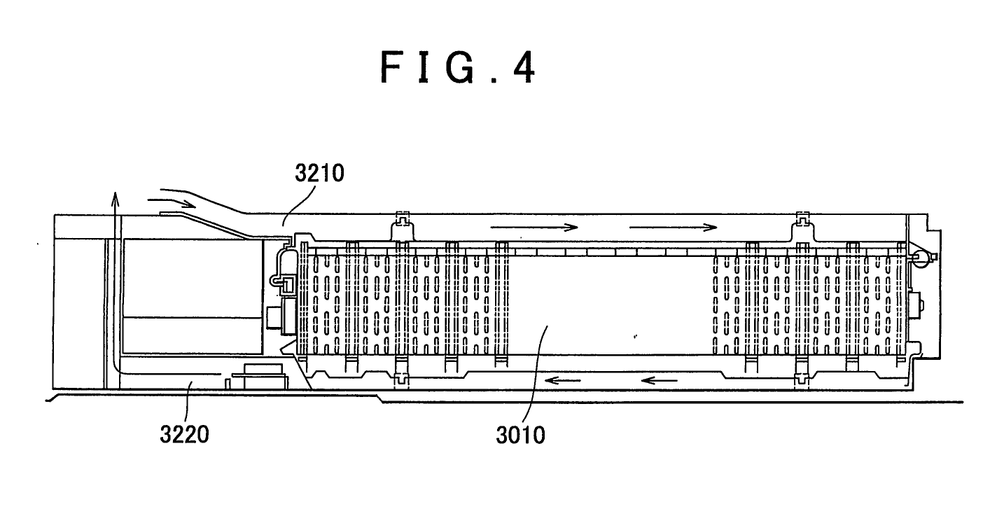

FIG. 4 is an enlarged view of the battery pack 3000 in FIG. 3. As shown in FIG. 4, the battery pack 3000 is formed of the multiple battery cells 3010, as described above. In the battery pack 3000, cooling air flows in the down flow method. Namely, the cooling air flows through the upper air passage 3210, flows downward through clearances between the battery cells 3010, and is introduced into the exhaust passage 3230 through the lower air passage 3220. The battery pack 3000 is appropriately cooled in the down flow cooling method. However, when the air whose heat has been exchanged with the heater core of the rear air conditioning unit 2000 is supplied to the battery pack 3000, the battery pack is appropriately heated instead of being appropriately cooled.

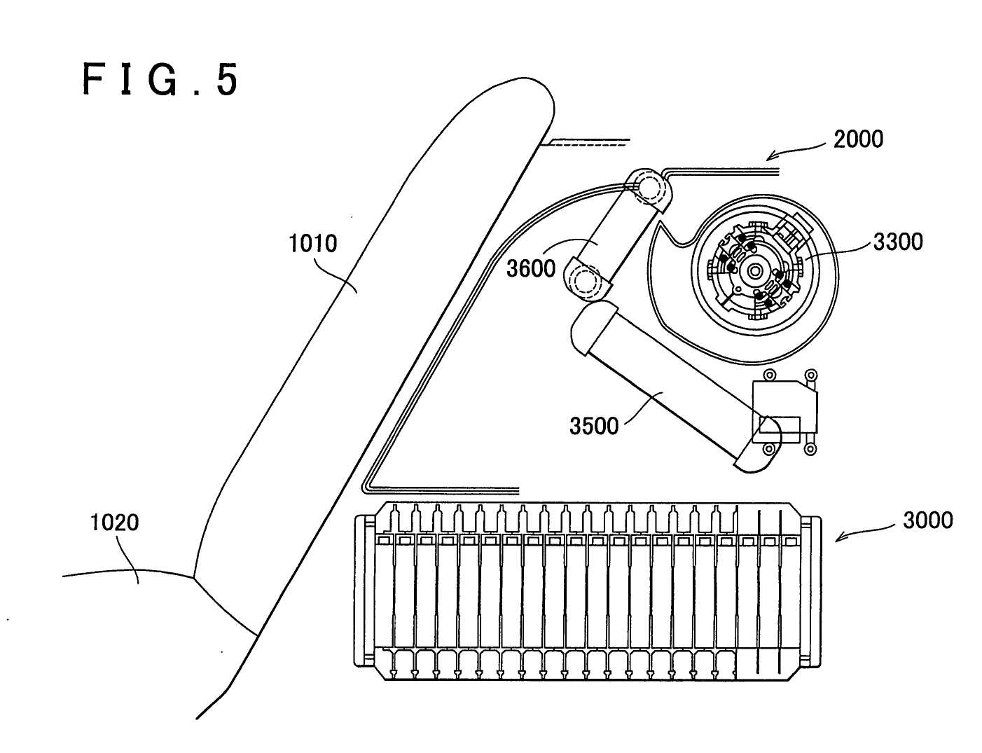

FIG. 5 is a side view showing the battery pack cooling system according to the embodiment, viewed from the side of the vehicle. As shown in FIG. 5, the rear air conditioning unit 2000 is provided in the rear portion of the vehicle at the position behind the rear seat back 1010. The rear air conditioning unit 2000 takes the air in the vehicle compartment therein through the vehicle compartment inlets 3310 formed in the upper back panel 5000. In the rear air conditioning unit 2000, heat of the air is exchanged with an evaporator 3500 or a heater core 3600 included in the rear air conditioning unit 2000, and the air whose heat has been exchanged with the evaporator 3500 or the heater core 3600 is introduced into the air conditioning air intake passage 3340 of the changing damper 3100. A compressor of the rear air conditioning unit 2000 is driven by, for example, a pulley connected to a crank shaft pulley of an engine. Also, the compressor of the rear air conditioning unit 2000 may be an electric compressor, instead of being driven by the engine.

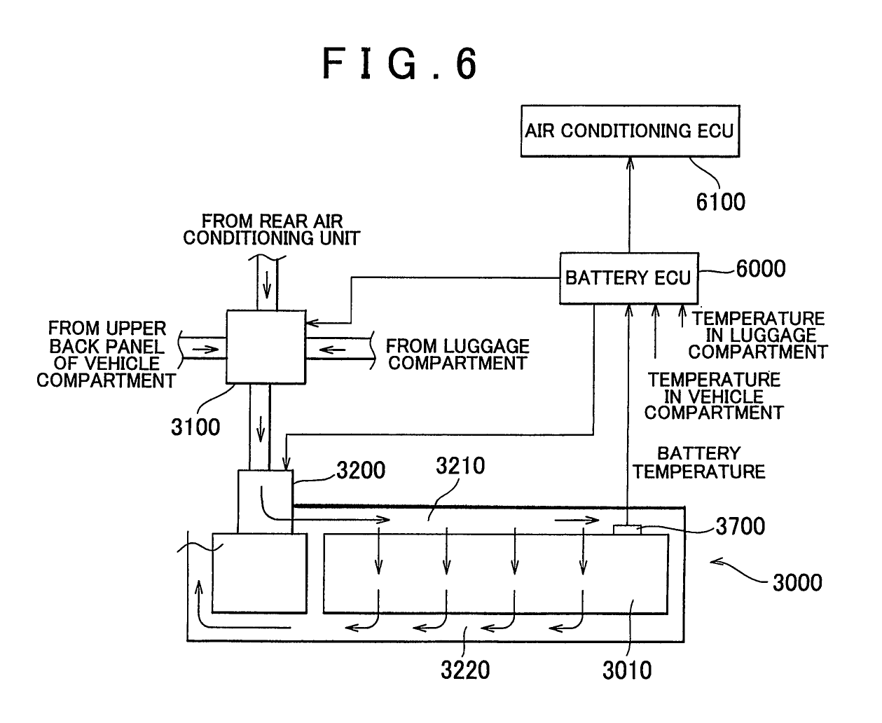

FIG. 6 is a control block diagram of the battery pack cooling system according to the embodiment of the invention As shown in FIG. 6, the battery pack cooling system includes the changing damper 3100; the battery fan 3200; the upper air passage 3210 of the battery pack 3000; the lower air passage 3220 of the battery pack 3000; a temperature sensor 3700; a battery ECU 6000; and an air conditioning ECU 6100. The changing damper 3100 supplies one of the air introduced from the upper back panel 5000 of the vehicle compartment, the air introduced from the rear air conditioning unit 2000, and the air introduced from the luggage compartment to the battery pack 3000 by using the battery fan 3200. The temperature sensor 3700 detects a temperature of the battery pack 3000. The battery ECU 6000 is connected to the changing damper 3100, the battery fan 3200 and the temperature sensor 3700, and controls the changing damper 3100 and the battery fan 3200 based on the battery temperature, the temperature in the vehicle compartment and the temperature in the luggage compartment. The air conditioning ECU 6100 controls the operation of the rear air conditioning unit 2000 according to a signal from the battery ECU 6000.

The battery fan 3200 controlled by the battery ECU 6000 may be an electric fan which is controlled by ON/OFF control, namely, which starts operating according to an operation signal from the battery ECU 6000 and which stops operating according to a stop signal from the battery ECU 6000. Also, the battery fan 3200 may be an electric fan which can change the amount of air in stages or continuously based on a control duty value provided by the battery ECU 6000.

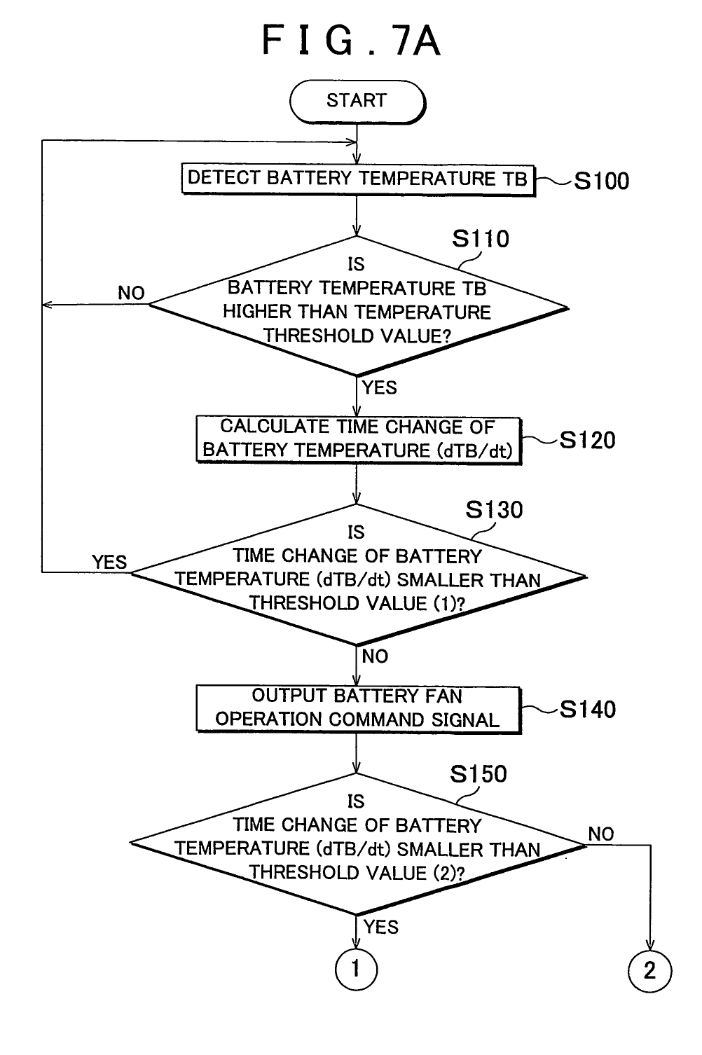

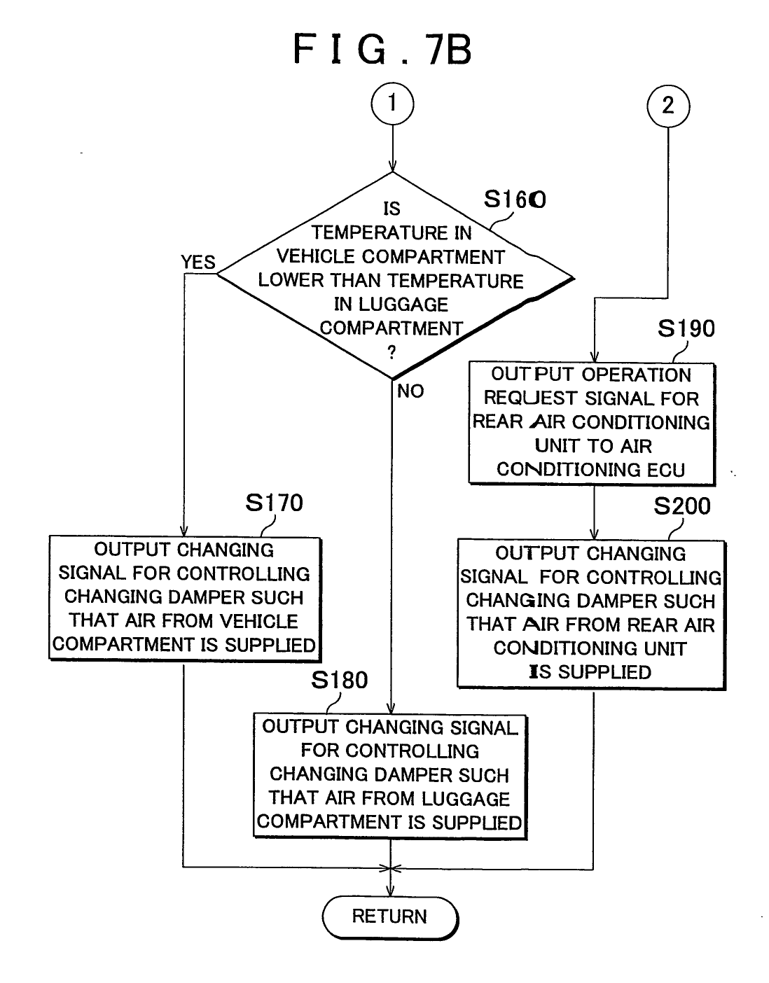

FIGS. 7A and 7B are a flowchart showing a routine of a program performed by the battery ECU 6000 in FIG. 6. In step S 100, the battery ECU 6000 detects a battery temperature TB. At this time, the battery ECU 6000 detects the battery temperature TB based on a battery temperature input from the temperature sensor 3700.

In step S110, the battery ECU 6000 determines whether the detected battery temperature TB is higher than a predetermined temperature threshold value. When it is determined that the battery temperature TB is higher than the predetermined temperature threshold value (“YES” in step S110), step S120 is then performed. When it is determined that the battery temperature is not higher than the temperature threshold value (“NO” in step S110), step S100 is performed again.

In step S120, the battery ECU 6000 calculates dTB/dt. Namely, the battery ECU 6000 calculates a time change of the battery temperature detected by the temperature sensor 3700 of the battery pack 3000.

In step S130, the battery ECU 6000 determines whether the time change of the battery temperature (dTB/dt) is smaller than a predetermined threshold value (1). When it is determined that the time change of the battery temperature (dTB/dt) is smaller than the predetermined threshold value (1) (“YES” in step S130), step S100 is performed again. When it is determined than the time change of the battery temperature (dTB/dt) is not smaller than the predetermined threshold value (“NO” in step S130), step S140 is then performed.

In step S140, the battery ECU 6000 outputs a battery fan operation command signal to the battery fan 3200.

In step S150, the battery ECU 6000 determines whether the time change of the battery temperature TB (dTB/dt) is smaller than a predetermined threshold value (2). Note that the threshold value (1) is smaller than the threshold value (2) (threshold value (1)<threshold value (2)). When it is determined that the time change of the battery temperature TB (dTB/dt) is smaller than the predetermined threshold value (2) (“YES”, in step S150), step S160 is then performed. When it is determined that the time change of the battery temperature. TB (dTB/dt) is not smaller than the predetermined threshold value (2) (“NO”, in step S150), step S190 is then performed.

In step S160, the battery ECU 6000 determines whether the temperature in the vehicle compartment is lower than the temperature in the luggage compartment. When it is determined that the temperature in the vehicle compartment is lower than the temperature in the luggage compartment (“YES” in step S160), step S170 then is performed. When it is determined than the temperature in the vehicle compartment is not lower than the temperature in the luggage compartment (“NO” in step S160), step S180 is then performed.

In step S170, the battery ECU 6000 outputs a changing signal for controlling the changing damper 3100 such that the air supplied from the vehicle compartment is introduced into the battery pack 3000.

In step S180, the battery ECU 6000 outputs a changing signal for controlling the changing damper 3100 such that the air supplied from the luggage compartment is introduced into the battery pack 3000.

In step S190, the battery ECU 6000 outputs a rear air conditioning unit operation request signal to the air conditioning ECU 6100. In step S200, the battery ECU 6000 outputs a changing signal for controlling the changing damper 3100 such that the air supplied from the rear air conditioning unit 2000 is introduced into the battery pack 3000.

Hereafter, a description will be made concerning an operation of the battery pack cooling system according to the embodiment based on the above-mentioned structure and the flowchart.

In step S100, the battery temperature TB is detected at predetermined sampling intervals while the vehicle provided with such a battery pack cooling system is running. When the battery temperature TB is higher than the predetermined temperature threshold value (“YES” in step S110), the time change of the battery temperature is calculated in step S120.

When the time change of the battery temperature dTB/dt is equal to or larger than the predetermined threshold value (1) (“NO” in step 8130), the battery fan 3200 is operated in step S140. When the time change of the battery temperature dTB/dt is smaller than the predetermined threshold value (2) (“YES” in step S150), the degree of an increase in the temperature is equal to or larger than the threshold value (1) but smaller than the threshold value (2). Therefore, it is determined that the battery pack 3000 need not be cooled rapidly. Accordingly, the battery pack 3000 is cooled by using the air in the vehicle compartment or the air in the luggage compartment.

When it is determined that the temperature in the vehicle compartment is lower than the temperature in the luggage compartment (“YES” in step S160), the changing damper 3100 is controlled such that the air supplied from the vehicle compartment is introduced into the battery pack 3000. When it is determined that the temperature in the vehicle compartment is equal to or higher than the temperature in the luggage compartment (“NO” in step S160), the changing damper 3100 is controlled in step S180 such that the air supplied from the luggage compartment is introduced into the battery pack 3000.

Meanwhile, when it is determined that the time change of the battery temperature dTB/dt is equal to or larger than the threshold value (2) (“NO” in step S150), the temperature of the battery pack 3000 has started to increase rapidly. In such a case, the battery pack 3000 is cooled by using the air whose heat has been exchanged with the evaporator 3500 of the rear air conditioning unit 2000 and whose temperature has become low, instead of using the air in the vehicle compartment or the air in the luggage compartment.

Accordingly, the battery ECU 6000 outputs a rear air conditioning unit operation request signal to the air conditioning ECU 6100, and the rear air conditioning unit 2000 starts operating. Thus, a cooling system of the rear air conditioning unit 2000 starts operating, and a cooling medium is supplied to the evaporator 3500 of the rear air conditioning unit 2000. At this time, heat exchange is performed between the evaporator 3500 and the air taken in from the vehicle compartment, and the air having a low temperature is supplied to the changing damper 3100. In step S200, the changing damper 3100 is operated such that the air supplied from the rear air conditioning unit is supplied to the battery pack 3000. Then, the air whose heat has been absorbed by the evaporator 3500 of the rear air conditioning unit 2000 and whose temperature has become low is supplied to the battery pack 3000 by the battery fan 3200.

As described so far, with the battery pack cooling system according to the embodiment, the air to be supplied to the battery pack is changed among the air in the vehicle compartment, the air in the luggage compartment, and the air whose heat has been exchanged with the evaporator of the rear air conditioning unit, based on the battery temperature and the time change of the battery temperature, and the selected air is supplied to the battery pack. Particularly when the battery temperature is rapidly increasing, the battery pack is cooled by using the air whose heat has been exchanged with the evaporator of the rear air conditioning unit and whose temperature has become low, instead of using the air in the vehicle compartment or the air in the luggage compartment. It is therefore possible to avoid a sharp increase in the temperature of the battery pack.

In art relating to the invention, when the battery pack 3000 needs to be cooled by using the air in the vehicle compartment, the amount of air supplied by the battery fan 3200 is increased. However, in the battery pack cooling system according to the embodiment of the invention, the air whose heat has been exchanged with the rear air conditioning unit 2000 and whose temperature has become lower is used. Accordingly, it is not necessary to increase the air supplied by the battery fan 3200.

In the description of the above-mentioned embodiment with reference to FIGS. 7A and 7B, the changing damper 3100 is controlled based on the time change of the battery temperature. However, the changing damper 3100 may be controlled based on only the battery temperature TB.

In the above-mentioned embodiment, basically, the description is made concerning the case in which the battery pack 3000 is cooled. However, the invention is not limited to cooling of the battery pack 3000. The invention may be applied to the case in which the battery pack 3000 is heated in a cold area.

When the invention is applied to the case in which the battery pack 3000 is heated, multiple temperature threshold values are set in advance. The battery temperature TB is detected. When the battery temperature TB is lower than the lowest temperature threshold value, the battery pack 3000 is heated by using the air whose heat has been exchanged with the heater core of the rear air conditioning unit 2000. When the battery temperature TB is higher than the lowest temperature threshold value and the battery pack 3000 needs to be heated, the battery pack 3000 is heated by using the air whose temperature is higher between the air in the vehicle compartment and the air in the luggage compartment. In either of these cases, the battery fan 3200 is operated.

When the battery temperature TB is higher than the highest temperature threshold value, and the battery pack need not be cooled nor heated, the battery fan 3200 is not operated.

As described so far, by increasing the temperature of the battery pack 3000 and controlling the temperature such that the temperature is in the appropriate range, a desired output of the battery pack 3000 can be achieved.

The embodiment of the invention that has been disclosed in the specification is to be considered in all respects as illustrative and not restrictive. The technical scope of the invention is defined by claims, and all changes which come within the meaning and range of equivalency of the claims are therefore desired to be embraced therein.

1. A temperature control system for a vehicle comprising
a supply device that supplies air for controlling a temperature to a storage mechanism mounted in a vehicle;
an inlet port which is communicated with the supply device; and
a changing device that changes air to be supplied to the storage mechanism by the supply device between air whose heat has been exchanged with an air conditioning unit in an air pipe and air other than the air whose heat has been exchanged with the air conditioning unit, the changing device being provided in the air pipe between the supply device and the inlet port.

2. The temperature control system for a vehicle according to claim 1, wherein
the air other than the air whose temperature has been exchanged with the air conditioning unit is air in a vehicle compartment.

3. The temperature control system for a vehicle according to claim 2, further comprising:
a changing control device that controls the changing device based on a temperature of the storage mechanism and a temperature in the vehicle compartment.

4. The temperature control system for a vehicle according to claim 1, wherein
the air other than the air whose heat has been exchanged with the air conditioning unit is air in a vehicle compartment and air in a luggage compartment, and
the changing device changes the air to be supplied to the storage mechanism among the air whose heat has been exchanged with the air conditioning unit, air in a vehicle compartment, and air in a luggage compartment.

5. The temperature control system for a vehicle according to claim 4, further comprising:
a changing control device that controls the changing device based on a temperature of the storage mechanism, a temperature in the vehicle compartment and a temperature in the luggage compartment.

6. The temperature control system for a vehicle according to claim 3, wherein
the changing control device controls the changing device such that, as the temperature of the storage mechanism becomes higher, air whose temperature is lower is supplied to the storage mechanism.

7. The temperature control system for a vehicle according to claim 3, wherein
the changing control device controls the changing device such that, as the temperature of the storage mechanism becomes lower, air whose temperature is higher is supplied to the storage mechanism.

8. The temperature control system for a vehicle according to claim 3, wherein
the changing control device controls the changing device based on a change in the temperature of the storage mechanism.

9. The temperature control system for a vehicle according to claim 8, wherein
the changing control device controls the changing device such that, as a degree of an increase in the temperature of the storage mechanism becomes higher, air whose temperature is lower is supplied to the storage mechanism.

10. The temperature control system for a vehicle according to claim 3 further comprising:
a supply control device that controls the supply device based on the temperature of the storage mechanism.

11. The temperature control system for a vehicle according to claim 10, wherein
the supply control device controls the supply device such that the supply device is operated when the temperature of the storage mechanism is higher than a predetermined threshold value.

12. The temperature control system for a vehicle according to claim 10, wherein
the supply control device controls the supply device such that the supply device is operated when the temperature of the storage mechanism is lower than a predetermined threshold value.

13. The temperature control system for a vehicle according to claim 3, wherein
the supply control device controls the supply device based on a change in the temperature of the storage mechanism.

14. The temperature control system for a vehicle according to claim 13, wherein
the supply control device controls the supply device such that the supply device is operated when a degree of an increase in the temperature of the storage mechanism is higher than a predetermined threshold value.

15. The temperature control system for a vehicle according to claim 5, further comprising:
supply control device for controlling the supply device based on the temperature of the storage mechanism, wherein
a low temperature side threshold value and a high temperature side threshold value are set for the temperature of the storage mechanism in advance,
when the temperature of the storage mechanism is lower than the low temperature side threshold value, the changing control device controls the changing device such that the air whose heat has been exchanged with the air conditioning unit is used as the air to be supplied to the storage mechanism, and the supply control device controls the supply device such that the supply device is operated,
when the temperature of the storage mechanism is higher than the low temperature side threshold value and lower than the high temperature side threshold value and the storage mechanism needs to be heated, the changing control device controls the changing device such that one of the air in the vehicle compartment and the air in the luggage compartment, which has the higher temperature, is used as the air to be supplied to the storage mechanism, and the supply control device controls the supply device such that the supply device is operated; and
when the temperature of the storage mechanism is higher than the high temperature side threshold value and the storage mechanism need not be cooled nor heated, the supply control device controls the supply device such that the supply device is not operated.

16. The temperature control system for a vehicle according to claim 1, wherein
the air whose heat has been exchanged with the air conditioning unit is air whose heat has been exchanged with one of an evaporator and a heater core.

17. The temperature control system for a vehicle according to claim 1, wherein
the storage mechanism is mounted in a rear portion of the vehicle,
the air conditioning unit is a rear air conditioning unit, and
the supply device is a blower which supplied air to the storage mechanism.

18. The temperature control system for a vehicle according to claim 17, wherein
the storage mechanism is a secondary battery for running.

19. The temperature control system for a vehicle according to claim 17, wherein
the air conditioning unit includes an evaporator and a heater core for the rear air conditioning unit provided near the storage mechanism in addition to an evaporator and a heater core for a front air conditioning unit, and
the air whose heat has been exchanged with the air conditioning unit is air whose heat has been exchanged with one of the evaporator and the heater core of the rear air conditioning unit.
